(19) United States
(12) Patent Application Publication
(10) Pub. No.: US 2015/0195119 A1
(43) Pub. Date: Jul. 9, 2015

(54) METHOD AND APPARATUS FOR TRANSMITTING AND RECEIVING SIGNAL IN OFDM SYSTEM

(71) Applicant: Electronics and Telecommunications Research Institute, Daejeon (KR)

(72) Inventors: Jin Hyuk SONG, Seoul (KR); Jong Soo LIM, Daejeon (KR); Heung Mook KIM, Daejeon (KR)

(21) Appl. No.: 14/309,570

(22) Filed: Jun. 19, 2014

(30) Foreign Application Priority Data
Jan. 7, 2014 (KR) 10-2014-0002055

(51) Int. Cl. H04L 27/36; H04L 27/38; H04L 27/26

(52) U.S. Cl. CPC H04L 27/362; H04L 27/2628; H04L 27/265; H04L 27/38

(57) ABSTRACT

In an orthogonal frequency division multiplexing (OFDM) wireless communication system, by modulating a phase of a symbol signal of source data to transmit and by performing constellation mapping of additional data having a coded channel and a signal having a modulated phase, a transmitting signal in which the additional data and the signal having a modulated phase are coupled is generated and transmitted.

### CROSS-REFERENCE TO RELATED APPLICATION

This application claims priority to and the benefit of Korean Patent Application No. 10-2014-0002055 filed in the Korean Intellectual Property Office on Jan. 7, 2014, the entire contents of which are incorporated herein by reference.

### BACKGROUND OF THE INVENTION

(a) Field of the Invention

The present invention relates to a method of modulating and transmitting a signal in an orthogonal frequency division multiplexing (OFDM) system, a method of receiving a modulated signal, and a transmitting apparatus and receiving apparatus using such methods.

(b) Description of the Related Art

When transmitting data of a high speed with a single-carrier using a multipath channel, a phenomenon in which transmitting data is distorted by intersymbol interference (ISI) frequently occurs. In order to solve such a problem, OFDM, which is a multi-carrier method of changing data of a high speed to data of a low speed and transmitting the data using several sub-carriers, has been spotlighted. OFDM was selected as fourth generation mobile communication and a European next generation digital broadcasting standard, and distributes data to many carriers that are separated by a predetermined gap from an accurate frequency. OFDM is a kind of multicarrier modulation method, and represents excellent performance in a multi-path and mobile receiving environment.

However, in OFDM that is multiplexed with a plurality of carriers, as a signal that is formed with a plurality of subcarriers is added with an in-phase on a time domain, a large peak to average power ratio (PAPR) occurs. Because such a large PAPR overpasses a linear dynamic range of a power amplifier and operates in a saturation range, a signal may be distorted. Therefore, an excessive dynamic range of the power amplifier is requested, and efficiency of the power amplifier is deteriorated.

In order to solve such a problem, an improved constant envelope OFDM (CE-OFDM) method of a combined form of OFDM and an analog method (FM/PM) has been developed. The CE-OFDM method shows a characteristic that signals having a PAPR of 0 dB in a baseband and that are formed with a plurality of subcarriers have an amplitude of the same magnitude in a time axis.

The OFDM method requires an expensive and inefficient power amplifier requiring high linearity due to a high PAPR, while the CE-OFDM method modulates a phase of an output signal of inverse fast Fourier transform (IFFT) while maintaining a merit of OFDM, and thus has a characteristic that a PAPR is 0 dB, thereby having good power efficiency.

However, because the CE-OFDM method limits an input of phase modulation to a real number value, the CE-OFDM method has a drawback that a data rate decreases to half.

### SUMMARY OF THE INVENTION

The present invention has been made in an effort to provide a transmitting/receiving method and apparatus having advantages of being capable of improving a data rate through additional data transmission in a CE-OFDM wireless communication system.

An exemplary embodiment of the present invention provides a transmitting method in an orthogonal frequency division multiplexing (OFDM) wireless communication system, the transmitting method including: generating a symbol signal of source data to transmit; performing inverse fast Fourier transform (IFFT) processing of the symbol signal; modulating a phase of the IFFT processed signal; generating a transmitting signal in which additional data and a signal having a modulated phase are coupled by performing constellation mapping of additional data having a coded channel and the signal having a modulated phase; and transmitting the transmitting signal.

The generating of a transmitting signal may include rotating a phase of the signal having a modulated phase based on the additional data in an opposite direction based on a y-axis.

The rotating of a phase of the signal may include: rotating, when a value of the additional data is 0, a phase of the signal having a modulated phase in an opposite direction based on a y-axis; and not rotating, when a value of the additional data is 1, the signal having a modulated phase.

The generating of a transmitting signal may further include generating the transmitting signal by coupling the rotated signal having a modulated phase and the unrotated signal having a modulated phase. The transmitting signal may include signals that are disposed at a left portion and a right portion based on a y-axis in a constellation.

The transmitting method may further include clipping the IFFT processed signal, after the performing of IFFT processing.

The clipping of the IFFT processed signal may include limiting a phase of the IFFT processed signal to a value of a predetermined range of −

$$\frac{π}{2} to \frac{π}{2} .$$

The transmitting method may further include arranging the symbol signals on a frequency axis, after the generating of a symbol signal.

Another embodiment of the present invention provides a transmitting apparatus in an orthogonal frequency division multiplexing (OFDM) wireless communication system, the transmitting apparatus including: a mapper that generates a symbol signal of source data to transmit; an IFFT unit that performs inverse fast Fourier transform (IFFT) processing of the symbol signal; a phase modulation unit that modulates a phase of the IFFT processed signal; and a constellation mapping unit that generates a transmitting signal in which additional data having a coded channel and the signal having a modulated phase are coupled by performing constellation mapping of additional data having a coded channel and the signal having a modulated phase.

The constellation mapping unit may generate a transmitting signal in which the rotated signal having a modulated phase and the unrotated signal having a modulated phase are coupled by selectively performing a process of rotating a phase of the signal having a modulated phase in an opposite direction based on a y-axis based on a value of the additional data.

The transmitting apparatus may further include a clipping unit that dips the IFFT processed signal and that outputs the IFFT processed signal to the phase modulation unit.

Yet another embodiment of the present invention provides a receiving method in an orthogonal frequency division multiplexing (OFDM) wireless communication system, the receiving method including: receiving a signal in which source data include a signal having a modulated phase from a transmitting apparatus; estimating additional data from the receiving signal; in estimating the signal having a modulated phase by selectively rotating a phase of the received signal based on the estimated additional data; demodulating a phase of the estimated signal having a modulated phase; performing FFT processing of the demodulated signal; and acquiring the source data by demapping the FFT processed signal.

The estimating of additional data may include estimating additional data according to a constellation of the received signal.

The estimating of additional data may include: estimating additional data to be “1”, when a real number value of a signal that is mapped in a first direction is equal to or larger than 0 in the constellation of the received signal; and estimating additional data to be “0” when a real number value of a signal that is mapped in a first direction of the constellation of the received signal is smaller than 0. The first direction may correspond to a right portion based on a y-axis on the constellation.

The estimating of the signal having a modulated phase may include: rotating a phase of the received signal to the opposite side based on a y-axis when the estimated additional data is “0”; and not performing rotation processing when the estimated additional data is not “0”.

Yet another embodiment of the present invention provides a receiving apparatus in an orthogonal frequency division multiplexing (OFDM) wireless communication system, the receiving apparatus including: a constellation extractor that receives a signal in which source data include a signal having a modulated phase from a transmitting apparatus and that estimates the signal having a modulated phase by selectively rotating a phase of the receiving signal based on additional data; a phase demodulation unit that demodulates a phase of the estimated signal having a modulated phase; an FFT unit that performs FFT processing of the demodulated signal; and a demapper that acquires the source data by demapping the FFT processed signal.

The constellation extractor may estimate the additional data based on a real number value of a signal that is disposed in a first direction on a constellation of the received signal.

The constellation extractor may estimate the signal having a modulated phase through a process that rotates a phase of the received signal to the opposite side based on a y-axis when the estimated additional data is “0”, and that does not perform a rotation processing when the estimated additional data is not “0”.

The receiving apparatus may further include a channel decoding unit that acquires original additional data by decoding a channel of the estimated additional data.

### BRIEF DESCRIPTION OF THE DRAWINGS

FIG. 1 is a block diagram illustrating a structure of a transmitting apparatus in an orthogonal frequency division multiple system according to an exemplary embodiment of the present invention.

FIG. 2 is a diagram illustrating a disposition of signals to modulate a phase in a CE-OFDM system according to an exemplary embodiment of the present invention.

FIG. 3 is a diagram illustrating a structure of a receiving apparatus in an orthogonal frequency division multiple system according to an exemplary embodiment of the present invention.

FIG. 4 is a diagram illustrating a distribution of an IFFT output signal according to a scale value, and FIG. 5 is a diagram illustrating a constellation of a signal having a modulated phase.

FIG. 6 is a diagram illustrating a constellation mapping process according to an exemplary embodiment of the present invention.

FIG. 7 is a diagram illustrating a constellation mapping example according to an exemplary embodiment of the present invention.

FIG. 8 is a diagram illustrating a constellation extracting process according to an exemplary embodiment of the present invention.

FIG. 9 is a graph illustrating receiving performance according to an exemplary embodiment of the present invention.

FIG. 10 is a flowchart illustrating a transmitting method according to an exemplary embodiment of the present invention.

FIG. 11 is a flowchart illustrating a receiving method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a transmitting/receiving method and apparatus according to an exemplary embodiment of the present invention will be described.

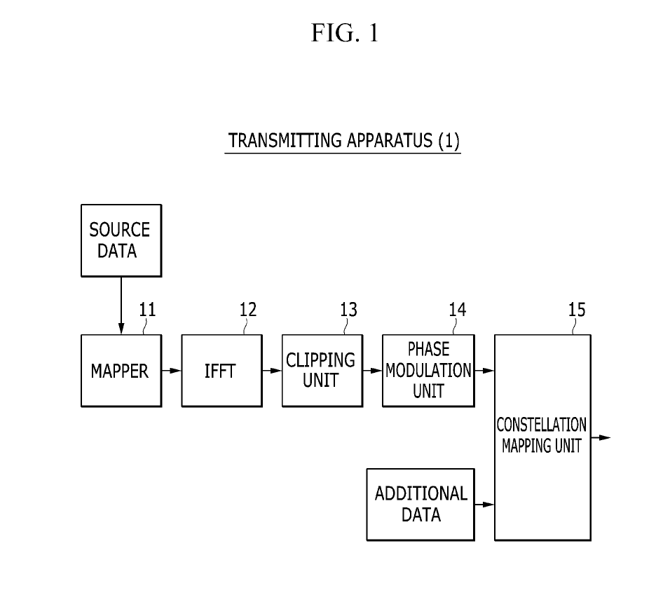

FIG. 1 is a block diagram illustrating a structure of a transmitting apparatus in a constant envelope (CE) orthogonal frequency division multiplexing (OFDM) wireless communication system according to an exemplary embodiment of the present invention.

As shown in FIG. 1, a transmitting apparatus 1 according to an exemplary embodiment of the present invention includes a mapper 11, an inverse fast Fourier transform (IFFT) unit 12, a clipping unit 13, a phase modulation unit 14, and a constellation mapping unit 15.

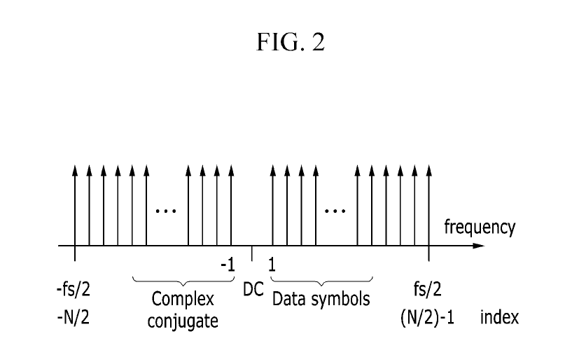

The mapper 11 modulates input source data and outputs the modulated source data as a symbol signal. The mapper 11 performs modulation of quadrature phase shift keying (QPSK), 16-quadrature amplitude modulation (QAM), and 64-QAM, and converts source data to a symbol signal. For phase modulation in the CE-OFDM system, a signal that is input to the phase modulation unit 14 should only have a real number value. Symbol signals that are output from the mapper 11 according to such an input signal condition are arranged at a frequency position of FIG. 2.

FIG. 2 is a diagram illustrating a disposition of signals to modulate a phase in a CE-OFDM system according to an exemplary embodiment of the present invention.

Before inputting to the IFFT unit 12 after outputting from the mapper, symbol signals are arranged at a predetermined gap on a frequency axis, as shown in FIG. 2.

The IFFT unit 12 outputs an input symbol signal as a signal on a time domain by performing IFFT processing, processes symbol signals that are formed with a real number value, and outputs the processed symbol signals as a signal on a time domain, as shown in FIG. 2.

The clipping unit 13 clips and outputs a signal that is output from the IFFT unit 12, and this is to partially limit a value of a signal so as to reduce an error by wrong mapping in a constellation mapping process to be described later.

The phase modulation unit 14 modulates a phase of signals that are output from the clipping unit 13 on a time domain. The phase modulation unit 14 may perform signal distribution adjustment that adjusts a signal distribution.

The constellation mapping unit 15 performs constellation mapping of input additional data, synthesizes a mapping signal of additional data in which constellation mapping is performed and a phase modulation signal that is output from the phase modulation unit 14, and outputs the synthesized signal as a transmitting signal. Constellation mapping of such additional data will be described in detail later.

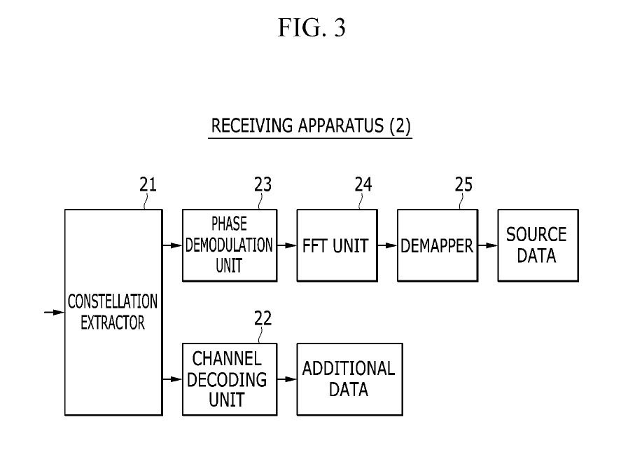

FIG. 3 is a diagram illustrating a structure of a receiving apparatus in a CE-OFDM wireless communication system according to an exemplary embodiment of the present invention.

As shown in FIG. 3, a receiving apparatus 2 according to an exemplary embodiment of the present invention includes a constellation extractor 21, a channel decoding unit 22, a phase demodulation unit 23, an FFT unit 24, and a demapper 25.

A transmitting signal that is transmitted from the transmitting apparatus 1 is received by the receiving apparatus 2, and a received signal is processed into a signal of a baseband and is input to the constellation extractor 21.

By performing constellation extraction of the input received signal, the constellation extractor 21 acquires estimated additional data and an estimated signal having a modulated phase. Such constellation extraction will be described in detail later.

The channel decoding unit 22 performs channel decoding of estimated additional data and acquires original additional data.

The phase demodulation unit 23 demodulates a phase of a signal that is output from the constellation extractor 21, i.e., an estimated signal having a modulated phase.

The FFT unit 24 performs FFT processing of a signal having a demodulated phase and outputs the signal as a signal of a frequency domain. The demapper 25 demodulates the signal of a frequency domain and outputs data corresponding to a received signal.

Hereinafter, a transmitting/receiving method according to an exemplary embodiment of the present invention based on such a structure will be described.

By modulating data to transmit, the transmitting apparatus 1 according to an exemplary embodiment of the present invention outputs the modulated data as a symbol signal, arranges symbol signals on a frequency axis for phase modulation, and performs IFFT processing of the symbol signals.

Additional data may be transmitted using statistical characteristics of an output signal of IFFT, i.e., an input signal that is input to the phase modulation unit 14. The output signal of IFFT is represented by Equation 1.

$$x [ n ] = {\sum }_{k = 0}^{N - 1} X [ k ] exp ( j \frac{2 π kn}{N} ) , n = 0 , 1 , … , N - 1 \qquad ( Equation 1 )$$

Here, N represents an FFT magnitude, X[k] represents a symbol signal, and symbol signals are disposed as shown in FIG. 3 so as to have a real number value x[n]. X[n] has an average value of 0 and a Gaussian distribution by the central limit theorem, and a distribution of an output signal of IFFT is represented by Equation 2.

$${f}_{s} ( x ) = \frac{1}{\sqrt{2 {πσ}_{x}}} {e}^{\frac{{x}^{2}}{2 \cdot {σ}_{x}^{2}}} \qquad ( Equation 2 )$$

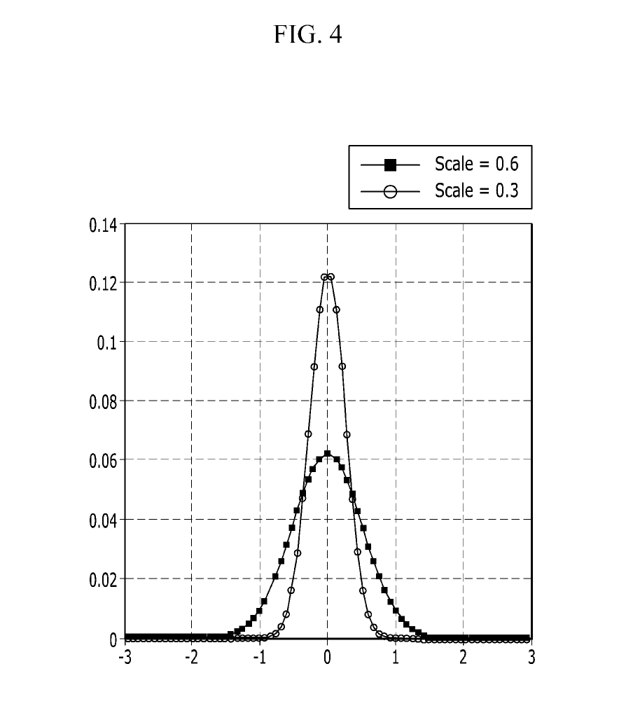

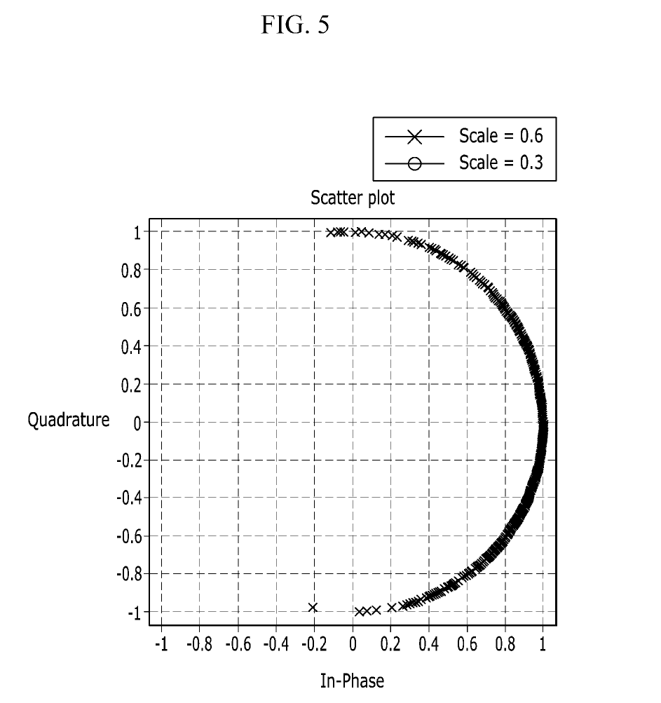

A magnitude of an output signal of IFFT is distributed as shown in FIG. 4 by Equation 1.

FIG. 4 is a diagram illustrating a distribution of an IFFT output signal according to a scale value, and FIG. 5 is a diagram illustrating a constellation of a signal having a modulated phase.

FIGS. 4 and 5 illustrate a distribution and constellation using, for example, a case in which N is 2048 and data is 1536 in a system using a transmitting mode 2 k mode of a digital video broadcasting-terrestrial version 2 (DVB-T2) standard among entire systems using CE-OFDM.

By multiplying a scaling factor of an appropriate magnitude by an output signal of IFFT, receiving performance is improved, and by multiplying 0.3 and 0.6 as a scaling factor by an output signal x[n] of IFFT, a distribution of an output signal of IFFT of FIG. 4 is obtained. When a phase of an output signal of IFFT having such distribution characteristics is modulated, the constellation of FIG. 5 may be obtained.

Referring to FIG. 4, statistical characteristics (dispersion of a Gaussian distribution) are determined according to a scale value, and referring to FIG. 5, when a scale of a small value is selected, it can be determined that a signal is mapped only to a right portion of constellation. In an exemplary embodiment of the present invention, by additionally performing a constellation mapping process according to additional data using a left portion that is not used in the constellation based on such a result, data transmission efficiency is increased.

As a scale of a high value is selected, a probability to be mapped to a left portion of the constellation increases. In such a case, a signal before a constellation mapping process cannot be distinguished from a signal after a constellation mapping process and an error occurs. Therefore, in an exemplary embodiment of the present invention, in order to reduce an error by wrong mapping, by performing dipping of an output signal of IFFT, a value of a signal that is input to the phase modulation unit 14 is limited.

$${x}_{clipping} [ n ] = \{ \begin{matrix}x [ n ] & \vert x [ n ] \vert \leq \frac{π}{2} \\ \frac{π}{2} & x [ n ] > \frac{π}{2} \\ - \frac{π}{2} & x [ n ] < - \frac{π}{2}\end{matrix} \qquad ( Equation 3 )$$

As in Equation 3, when a phase of the IFFT output signal is larger than

$$\frac{π}{2}$$

or smaller than

$$- \frac{π}{2} ,$$

a phase of a corresponding signal is fixed to a limited value of

$$\frac{π}{2} or - \frac{π}{2} .$$

In this way, a signal whose phase is limited to a value of a predetermined range is input to the phase modulation unit 14. The phase modulation unit 14 modulates and outputs a phase of an input signal.

In order to improve a data rate, the constellation mapping unit 15 performs constellation mapping of additional data. Here, the additional data is data having a coded channel. Specifically, the constellation mapping unit 15 receives an input of a signal having a modulated phase and additional data having a coded channel, and outputs the signal and the data as a signal of a coupled form. A processing process of such a constellation mapping unit 15 is represented by Equation 4.

$$s [ n ] = exp ( {jαx}_{clipping} [ n ] ) , \\ {s}_{add} [ n ] = \{ \begin{matrix}s [ n ] & m [ n ] == 1 \\ s [ n ] - 2 ℛ ( s [ n ] ) & m [ n ] == 0\end{matrix} \qquad ( Equation 4 )$$

Here, s[n] represents a signal having a modulated phase that is output from the phase modulation unit 14, m[n] represents additional data having a coded channel, and s_{add}[n] represents a signal that is output from the constellation mapping unit 15. Further, exp[•] represents phase modulation, and a represents a scale value.

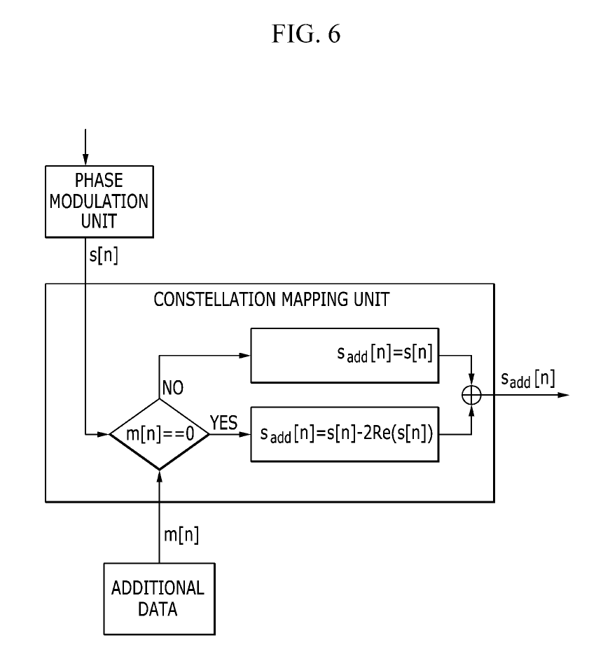

FIG. 6 is a diagram illustrating a constellation mapping process according to an exemplary embodiment of the present invention.

As shown in FIG. 6, an output signal s_{add}[n] of the constellation mapping unit 15 is determined according to a value of additional data m[n], and if m[n] is 0, a phase of the signal s[n] having a modulated phase is rotated to the opposite side based on a y-axis, and if m[n] is not 0, separate processing of the signal s[n] having a modulated phase is not performed. Additional data may be transmitted using a left portion that is not used in the constellation of FIG. 5 through such a process. Further, in the constellation, because a signal is mapped in one circle, the PAPR is not changed.

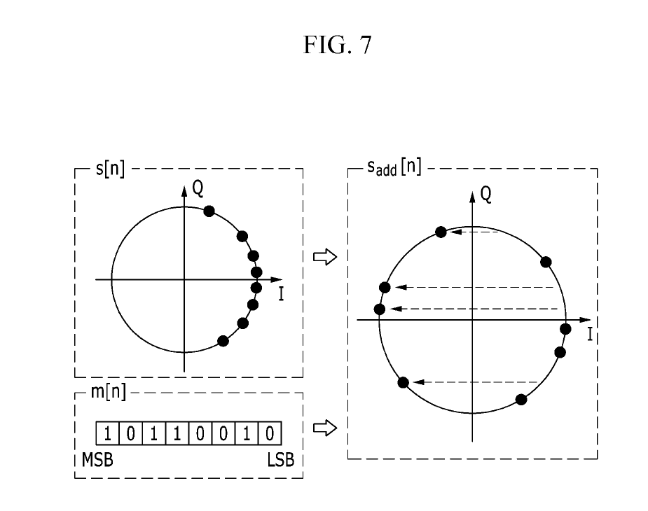

For example, it is described that a constellation mapping process is performed using s[n] and m[n] having only 8 values. FIG. 7 shows diagrams illustrating a constellation mapping example according to an exemplary embodiment of the present invention.

As shown in the first diagram FIG. 7, when selectively performing a process of rotating a phase of a signal s[n] having a modulated phase that is positioned at a left portion of the constellation to the opposite side based on a y-axis based on additional data m[n] of “10110010”, a constellation of the second diagram of FIG. 7 is acquired. That is, only when m[n] is “0”, by rotating a phase of a value of the signal s[n] having a modulated phase to the opposite side, as shown in the second diagram of FIG. 7, a signal s_{add}[n] that is distributed at the left side and the right side of the constellation is formed.

In this way, a signal s_{add}[n] in which the constellation is mapped is transmitted through a channel.

The receiving apparatus 2 receives a signal that is transmitted from the transmitting apparatus 1, and the received signal is represented by Equation 5. Here, it is assumed that a channel is an additive white Gaussian noise (AWGN) channel.

r[n]=s_{add}[n]+w[n] (Equation 5)

Here, r[n] represents a received signal, and w[n] represents AWGN.

The receiving apparatus 2 performs a constellation extracting process that acquires s[n] and mini by processing s_{add}[n] in the received signal.

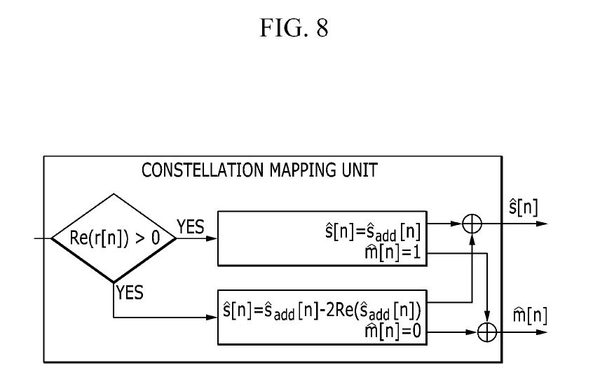

FIG. 8 is a diagram illustrating a constellation extracting process according to an exemplary embodiment of the present invention.

The constellation extracting process is largely formed with two steps.

First, additional data is estimated according to constellation of a received signal r[n]. If a real number value of r[n] that is mapped at the right side of constellation is equal to or larger than 0, additional data is estimated to be “1”, and if a real number value of r[n] that is mapped at the right side of constellation is smaller than 0, additional data is estimated to be “0”.

Second, for phase demodulation, a step of again moving a constellation mapped signal to an original position is performed. If estimated additional data is “0”, a phase of s_{add}[n] of the received signal r[n] is rotated to the opposite side based on a y-axis, and if estimated additional data is not “0”, separate processing is not performed. Such a constellation extracting process is represented by Equation 6.

$$\hat{m} [ n ] = \{ \begin{matrix}1 , & ℛ ( {\hat{s}}_{add} [ n ] ) > 0 \\ 0 , & ℛ ( {\hat{s}}_{add} [ n ] ) < 0\end{matrix} \\ \hat{s} [ n ] = \{ \begin{matrix}{\hat{s}}_{add} [ n ] , & \hat{m} [ n ] == 1 \\ {\hat{s}}_{add} [ n ] - 2 ℛ ( {\hat{s}}_{add} [ n ] ) , & \hat{m} [ n ] == 0\end{matrix} \qquad ( Equation 6 )$$

Here, ŝ[n] represents an estimated signal having a modulated phase, and \hat{m}[n] represents estimated additional data.

The estimated signal ŝ[n] having a modulated phase is acquired according to the estimated additional data \hat{m}[n].

Thereafter, the receiving apparatus 2 performs phase demodulation processing of the estimated signal ŝ[n] having a modulated phase, performs FFT processing of the demodulated signal, and acquires source data by demapping the signal.

In such a transmitting/receiving method according to an exemplary embodiment of the present invention, frequency use efficiency is represented by Equation 7.

β=log₂(M)/2+1 (Equation 7)

Here, M is a constellation modulation level.

Because general CE-OFDM has frequency use efficiency of log₂(M)/2, a gain can always be obtained. As a value M increases, improvement of a data rate decreases, but in binary phase shift keying (BPSK), a data rate of three times is obtained, and in quadrature phase shift keying (QPSK), a data rate of two times is obtained.

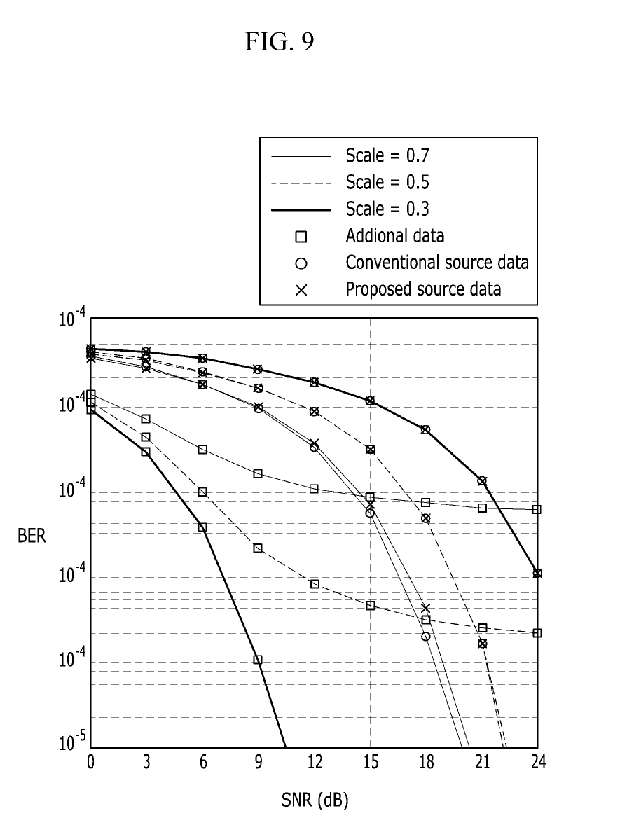

In order to compare receiving performance and a data rate according to an exemplary embodiment of the present invention, a simulation was performed in consideration of the following environment, and as a result thereof, a performance graph of FIG. 9 was obtained.

FIG. 9 is a graph illustrating receiving performance according to an exemplary embodiment of the present invention.

In FIG. 9, simulation was performed with a transmitting/receiving method according to an exemplary embodiment of the present invention under an environment in which N is 2048, the data number is 1536, a modulation method is 16QAM, a scale is 0.4-0.8, and the channel is an AWGN channel. It can be seen through FIG. 9 that receiving performance of a case of transmitting data (proposed source data) according to an exemplary embodiment of the present invention is improved.

The foregoing transmitting/receiving method is described according to flow as follows.

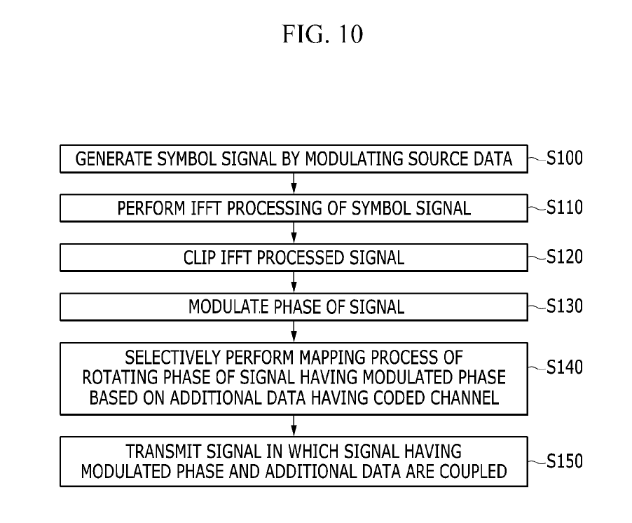

FIG. 10 is a flowchart illustrating a transmitting method according to an exemplary embodiment of the present invention.

The transmitting apparatus 1 generates a symbol signal by modulating source data (S100), and performs IFFT processing by arranging the symbol signal on a frequency axis (S110).

By clipping the IFFT processed signal, The transmitting apparatus 1 fixes a phase of the IFFT signal to a limited value, for example,

$$- \frac{π}{2} to \frac{π}{2}$$

of a predetermined range (S120). The transmitting apparatus 1 modulates a phase of a signal in which a phase is limited to a value of a predetermined range (S130).

In order to improve a data rate, the transmitting apparatus 1 performs a constellation mapping process that receives an input of a signal having a modulated phase and additional data having a coded channel, and that outputs the signal and the data to a signal of a coupled form (S140). That is, by selectively performing a process of rotating a phase of a signal having a modulated phase to the opposite side based on a y-axis according to a value of additional data having a coded channel, the transmitting apparatus 1 generates a signal in which a signal having a modulated phase and additional data are coupled. As described above, when a value of additional data is “0”, by performing a process of rotating a phase of a signal having a modulated phase to the opposite side based on a y-axis, the transmitting apparatus 1 generates a signal that is distributed in a left portion and a right portion based on a y-axis on constellation. Thereafter, the transmitting apparatus 1 processes and transmits a signal in which a signal having a modulated phase and additional data having a coded channel are coupled as a transmitting signal (S150).

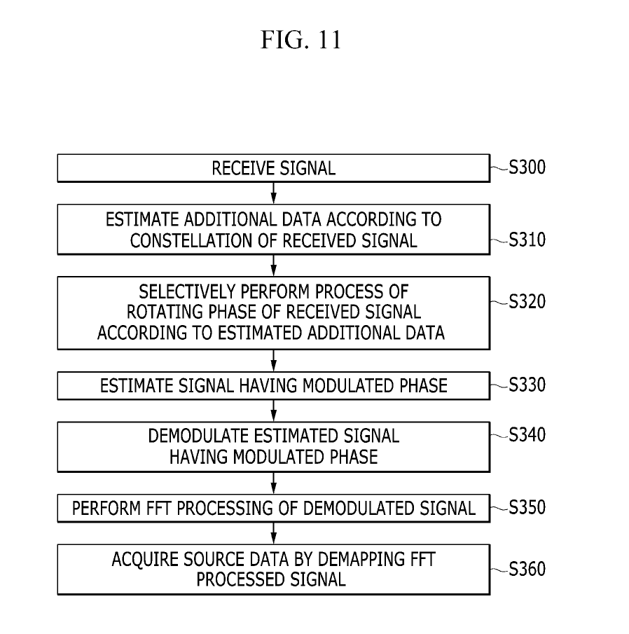

FIG. 11 is a flowchart illustrating a receiving method according to an exemplary embodiment of the present invention.

The receiving apparatus 2 receives a signal that is transmitted through a channel (S300), and performs constellation extraction of the received signal. First, the receiving apparatus 2 estimates additional data according to the constellation of the received signal, and determines a value of additional data to be “1” or “0” according to a real number value of a received signal that is mapped to the right side of constellation (S310).

Thereafter, the receiving apparatus 2 performs a process of again moving the constellation mapped signal to an original position based on the estimated additional data. By performing processing that rotates the received signal, particularly, a phase of the received signal, to the opposite side based on a y-axis according to the estimated additional data value (S320), the receiving apparatus 2 estimates a signal having a modulated phase (S330).

The receiving apparatus 2 performs phase demodulation processing of the estimated signal having a modulated phase (S340), and performs FFT processing of the demodulated signal (S350). By performing demodulation for demapping the FFT processed signal, the receiving apparatus 2 acquires source data (S360).

By performing channel decoding of estimated additional data, the receiving apparatus 2 can acquire original additional data that is provided from the transmitting apparatus 1.

According to an exemplary embodiment of the present invention, in a CE-OFDM wireless communication system, by changing a constellation of a signal having a modulated phase while maintaining a 0 dB PAPR through a constellation mapping and constellation extracting method, a data rate can be increased. Further, compatibility with existing CE-OFDM can be maintained through a constellation extracting process.

Further, a method according to an exemplary embodiment of the present invention can be used in a mobile communication receiving apparatus that is sensitive to a battery life-span and power consumption and a satellite communication transmitting apparatus requiring wide coverage in the same power, and can even be used in broadcasting that provides various services through additional data transmission. Further, when applying channel coding to source data and additional data, distortion can be reduced by clipping.

The foregoing exemplary embodiment of the present invention may not only be embodied through an apparatus and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmitting method in an orthogonal frequency division multiplexing (OFDM) wireless communication system, the transmitting method comprising:
generating a symbol signal of source data to transmit;
performing inverse fast Fourier transform (IFFT) processing of the symbol signal;
modulating a phase of the IFFT processed signal;
generating a transmitting signal in which additional data and the signal having a modulated phase are coupled by performing constellation mapping of the additional data having a coded channel and the signal having a modulated phase; and
transmitting the transmitting signal.

2. The transmitting method of claim 1, wherein the generating of a transmitting signal comprises rotating a phase of the signal having a modulated phase based on the additional data in an opposite direction based on a y-axis.

3. The transmitting method of claim 2, wherein the rotating of a phase of the signal comprises:
rotating, when a value of the additional data is 0, the phase of the signal having a modulated phase in an opposite direction based on a y-axis; and
not rotating, when a value of the additional data is 1, the signal having a modulated phase.

4. The transmitting method of claim 3, wherein the generating of a transmitting signal further comprises generating the transmitting signal by coupling the rotated signal having a modulated phase and the unrotated signal having a modulated phase.

5. The transmitting method of claim 4, wherein the transmitting signal comprises signals that are disposed at a left portion and a right portion based on a y-axis on a constellation.

6. The transmitting method of claim 1, further comprising clipping the IFFT processed signal, after the performing of IFFT processing.

7. The transmitting method of claim 6, wherein the clipping of the IFFT processed signal comprises limiting a phase of the IFFT processed signal to a value of a predetermined range of
$$- \frac{π}{2} to \frac{π}{2} .$$

8. The transmitting method of claim 1, further comprising arranging the symbol signals on a frequency axis, after the generating of a symbol signal.

9. A transmitting apparatus in an orthogonal frequency division multiplexing (OFDM) wireless communication system, the transmitting apparatus comprising:
a mapper that generates a symbol signal of source data to transmit;
an IFFT unit that performs inverse fast Fourier transform (IFFT) processing of the symbol signal;
a phase modulation unit that modulates a phase of the IFFT processed signal; and
a constellation mapping unit that generates a transmitting signal in which additional data having a coded channel and the signal having a modulated phase are coupled by performing constellation mapping of additional data having a coded channel and the signal having a modulated phase.

10. The transmitting apparatus of claim 9, wherein the constellation mapping unit generates a transmitting signal in which the rotated signal having a modulated phase and the unrotated signal having a modulated phase are coupled by selectively performing a process of rotating a phase of the signal having a modulated phase in an opposite direction based on a y-axis based on a value of the additional data.

11. The transmitting apparatus of claim 9, further comprising a clipping unit that clips the IFFT processed signal and that outputs the IFFT processed signal to the phase modulation unit.

12. A receiving method in an orthogonal frequency division multiplexing (OFDM) wireless communication system, the receiving method comprising:
receiving a signal in which source data comprises a signal having a modulated phase from a transmitting apparatus;
estimating additional data from the receiving signal;
estimating the signal having a modulated phase by selectively rotating a phase of the received signal based on the estimated additional data;
demodulating a phase of the estimated signal having a modulated phase;
performing FFT processing of the demodulated signal; and
acquiring the source data by demapping the FFT processed signal.

13. The receiving method of claim 12, wherein the estimating of additional data comprises estimating additional data according to a constellation of the received signal.

14. The receiving method of claim 13, wherein the estimating of additional data comprises:
estimating additional data to be “1”, when a real number value of a signal that is mapped in a first direction is equal to or larger than 0 in the constellation of the received signal; and
estimating additional data to be “0” when a real number value of a signal that is mapped in a first direction of the constellation of the received signal is smaller than 0.

15. The receiving method of claim 14, wherein the first direction corresponds to a right portion based on a y-axis on the constellation.

16. The receiving method of claim 12, wherein the estimating of the signal having a modulated phase comprises:
rotating a phase of the received signal to the opposite side based on a y-axis when the estimated additional data is “0”; and
not performing rotation processing when the estimated additional data is not “0”.

17. A receiving apparatus in an orthogonal frequency division multiplexing (OFDM) wireless communication system, the receiving apparatus comprising:
a constellation extractor that receives a signal in which source data comprises a signal having a modulated phase from a transmitting apparatus and that estimates the signal having a modulated phase by selectively rotating a phase of the receiving signal based on additional data;
a phase demodulation unit that demodulates a phase of the estimated signal having a modulated phase;
an FFT unit that performs FFT processing of the demodulated signal; and
a demapper that acquires the source data by demapping the FFT processed signal.

18. The receiving apparatus of claim 17, wherein the constellation extractor estimates the additional data based on a real number value of a signal that is disposed in a first direction on a constellation of the received signal.

19. The receiving apparatus of claim 17, wherein the constellation extractor estimates the signal having a modulated phase through a process that rotates a phase of the received signal to the opposite side based on a y-axis when the estimated additional data is “0”, and that does not perform rotation processing when the estimated additional data is not “0”.

20. The receiving apparatus of claim 17, further comprising a channel decoding unit that acquires original additional data by decoding a channel of the estimated additional data.
